(19) United States
(12) Patent Application Publication
(10) Pub. No.: US 2013/0247978 A1
(43) Pub. Date: Sep. 26, 2013

(54) TITANIUM DIOXIDE NANOPARTICLES FOR FABRICATING PHOTO-ELECTRODE FOR EFFICIENT, LONGLASTING DYE-SENSITIZED SOLAR CELL AND FABRICATION METHOD THEREOF

(71) Applicant: KOREA INSTITUTE OF SCIENCE AND TECHNOLOGY, Seoul (KR)

(72) Inventors: So Hye CHO, Seoul (KR); Jong Ku PARK, Gyeonggi-Do (KR); Hyun Seock JIE, Seoul (KR); Hyoung Il CHOI, Chungcheongbuk-Do (KR); Bong Geun SONG, Seoul (KR)

(73) Assignee: KOREA INSTITUTE OF SCIENCE AND TECHNOLOGY, Seoul (KR)

(21) Appl. No.: 13/899,930

(22) Filed: May 22, 2013

Related U.S. Application Data
(63) Continuation-in-part of application No. PCT/KR2011/007096, filed on Sep. 27, 2011.

(30) Foreign Application Priority Data
Nov. 23, 2010 (KR) 10-2010-0117123

(51) Int. Cl. H01G 9/20; H01G 9/00

(52) U.S. Cl. CPC H01G 9/2031; H01G 9/0029
USPC 136/256; 438/98

(57) ABSTRACT

It is disclosed that a photo-electrode of a dye-sensitized solar cell comprising faceted anatase-type titania nanoparticles which adequate for fabricating a photo-electrode of a dye-sensitized solar cell which is efficient and longlasting and a fabrication method thereof. The titania nanoparticles can provide high photoelectric conversion efficiency of the solar cell with help of fast electron mobility due to its high crystallinity and can reduce process time required for adsorbing the dye molecules on the surface of the titania nanoparticles.

By modifying surface characteristics of the titania nanoparticles, it is allowed for dye molecules to be easily adsorbed on the surface of the titania nanoparticles and the life span of the dye molecules adsorbed on it is expanded with help of reduced photo-degradation rate of them at service conditions.

### CROSS-REFERENCE TO RELATED APPLICATIONS

This application is a continuation-in-part application of PCT application No. PCT/KR2011/007096, filed on Sep. 27, 2011, related to subject matter contained in priority Korean Application No. 10-2010-0117123, filed on Nov. 23, 2010, the contents of which are hereby incorporated by reference herein in their entirety.

### TECHNICAL FIELD

The present invention relates to a photo-electrode of dye-sensitized solar cells comprising titanium dioxide nanoparticles which are very efficient and long-lasting and a fabrication method thereof. More particularly, the present invention relates to a titanium dioxide nanoparticle which is fabricated by high-temperature process to give high crystallinity and to have adequate conditions in a specific surface area, a particle shape, surface characteristics, and the like, as well. They can adsorb dye molecules very quickly, have a low rate of photodecomposition of the dye molecules adsorbed on the surface of titanium nanoparticles, and provide a photoelectrode for high photoelectric conversion efficiency of the dye-sensitized solar cell.

### BACKGROUND ART

A dye-sensitized solar cell (DSC or DSSC), a technique for converting light energy into electrical energy (photoelectric conversion) by using the principle of photosynthesis of plants, was developed by Prof. Michael Grätzel in 1991 at the Swiss Federal Institute of Technology (EPFL) in Lausanne (M. Grätzel, Nature, 353, 737 (1991)). As shown in FIG. 1, the DSSC basically includes a multi-layered structure implemented between a transparent front substrate and a rear substrate. The DSSC includes the transparent front substrate 1, a transparent electrode 2, porous photo-electrode layer 3 formed of partially sintered titania nanoparticles, dye-molecules 4 adsorbed on the surface of the porous photo-electrode layer 3, an electrolyte solution layer 5 (a portion of the electrolyte solution infiltrates into fine capillaries of the photo-electrode layer), a counter electrode 6 for reducing electrolyte 5, and a rear substrate 7. Because of this multilayered structure, the DSSC includes several interfaces (front substrate/transparent electrode, transparent electrode/photo-electrode, photo-electrode/dye-molecular layer, dye-molecular layer/electrolyte, electrolyte/counter electrode, counter electrode/rear substrate, etc.), and photoelectric conversion efficiency of the DSSC is determined by the characteristics of the involved interfaces along with physical properties (mobility of electrons or holes) of the respective layers. Among the various components comprising a DSSC, the characteristics of the titania photo-electrode layer and the interface related thereto are important. In order to increase electron mobility through the titania photo-electrode layer, the titania photo-electrode layer itself should have both high electric conductivity and a microstructure allowing electrons to flow smoothly. The titania photo-electrode has to be dense enough to make electrons flow fast to the transparent electrode, while, to the contrary, it should be porous enough to provide sufficient surface area for dye molecules to be adsorbed because the number of photo-generated electrons, corresponding to electric current, is determined by the number of dye molecules. Therefore, the ideal titania photo-electrode layer is usually fabricated from nano-size powder of titania. However, when the diameter of the titania particles is reduced below a few nanometers, various kinds of defects at the surface or in the interior of the titania particles increases, allowing electrons and holes photoelectrically generated to be recombined and then, lowering photoelectric conversion efficiency. Thus, a technique of regulating the size, shape, crystallinity, crystal microstructure (phase), and surface characteristics of the titania particles is crucial in the fabrication of titania photo-electrode for dye-sensitized solar cell.

Titania, as a material of the photo-electrode layer, has three phases: a high temperature type rutile phase, a low temperature type anatase phase, and a brookite phase in a metastable state. Compared with rutile form titania, the anatase form titania has higher electron mobility [J. Phys, Chem., 94, 8222 (1990)], faster adsorption of dye molecules [J. Mater, Sci., 38, 1065 (2003)], and a larger band gap (anatase phase, E_{g}=3.2 eV; rutile phase, E_{g}=3.0 eV), and the anatase form titania is preferred as a photoelectrode material. In addition, in order to obtain high electron mobility through the photo-electrode layer, the titania powders require to have high crystallinity with defects as low as possible. At the same time, occurrence of rutile form should be avoided during fabrication and subsequent heat treatment of titania powders. Since densification and coarsening of titania particles are being accompanied simultaneously during the fabrication of photo-electrode layer, it is very critical to preserve a specific surface area of the photo-electrode layer as large as possible to provide a number of dye molecules as much as possible.

Various techniques including vapor phase synthesis and liquid phase synthesis techniques are adapted to fabricate titania nanoparticles. Among them, a chemical vapor synthesis method where tetrachloride (TiCl₄) is used as a precursor and reacted at a high temperature after vaporization has been widely applied. On the other hand, a typical liquid phase synthesis method utilizing a sol-gel process with titanium alkoxide precursors also provides titania nanoparticles. During this sol-gel process, alkoxide is hydrolyzed to form a powder of titanium hydroxide, which is separated, washed, and then calcinated to obtain a titania powder. The method can provide titania nanoparticles at a low cost, but has a high chance of particle aggregation due to calcination at a relatively high temperature. When calcination is performed at a low temperature to minimize particle aggregation, the crystallinity of titania powder tends to be poor. To the contrary, when the calcination is done at high temperature, high crystallinity can be obtained but hard aggregates of titania particles and rutile phase are often found.

### DISCLOSURE OF THE INVENTION

An object of the present invention is to provide a titania nanoparticle adequate for fabricating a photo-electrode of efficient DSSC. The titania nanoparticle in the present invention can provide high photoelectric conversion efficiency of the solar cell with help of fast electron mobility due to its high crystallinity, and reduce process time required for adsorbing the dye molecules on the surface of the titania nanoparticle by modifying its surface characteristics to allow the dye molecules to be easily adsorbed, and finally, increase a life span of the dye molecules by reducing the rate of their photodegradation at service conditions.

In accordance with the purpose of the present invention, as embodied and broadly described herein, there is an anatase form titania nanoparticle for fabricating a photo-electrode of DSSC with a faceted shape of a truncated bipyramidal geometry in which {101} crystallographic planes are developed.

To achieve the above objects, there is also provided a method for preparing a titania nanoparticle for a photo-electrode of DSSC as follows: producing a titania nanoparticle through a chemical vapor synthesis using a titanium alkoxide precursor; post-annealing the titania nanoparticle to improve crystallinity of titania particle keeping anatase form; and to control a shape of the titania nanoparticle having a faceted shape with a truncated bipyramidal geometry in which {101} crystallographic planes are developed.

The said titania nanoparticle has high crystallinity and adequate characteristics such as crystal phase, specific surface area (size of particles), particle shape, and surface characteristics, required for obtaining high photoelectric conversion efficiency. In addition, it can adsorb dye molecules very quickly, whereby the dye adsorption time can be shortened. Photodecomposition of the adsorbed dye molecules is also retarded and thus, the life span of the solar cell can be lengthened.

Meanwhile, according to the said method for preparing a titania nanoparticle, an effective method for fabricating the titania nanoparticle having high quality can be provided.

To achieve the above objects, it is also provided that a photo-electrode of a dye-sensitized solar cell, comprising; faceted anatase-type titania nanoparticles having a truncated bipyramidal geometry with developed {101} crystallographic planes, wherein an adsorption rate of dye molecules is 80% or greater on the surface of the titania nanoparticles within five minutes when the dye molecules in a solution are in contact with the titania nanoparticles. The faceted anatase-type titania nanoparticles are very efficient and long-lasting for adsorbed dyes for the solar cell.

The specific surface area of the titania nanoparticles may be 80 m²/g or greater. The titania nanoparticles may have surface areas enough to adsorb dyes.

The titania nanoparticles may be 15 nm or smaller in size, or may be 10 nm to 15 nm in size. When the size of the titania nanoparticles is 15 nm or smaller, it may be easy to develop their shape to be a truncated bipyramidal geometry with developed {101} crystallographic planes. When the titania nanoparticles have developed {101} crystallographic planes, an absorption rate and an adsorption amount of dye molecules can be increased. It is considered that the {101} crystallographic planes can provide a kind of sites for the dye molecules to be located on the surface of the titania particle.

An amount of dye molecules adsorbed on the surface of the titania nanoparticles may be 90% or more of an initial amount thereof when the titania nanoparticles adsorbing the dye molecules are exposed for 15 hours under a metal-halogen lamp.

Since the titania nanoparticles have a truncated bipyramidal geometry, when the {101} crystallographic planes located at the sides of bipyramidal are developed, the surface area of the {001} crystallographic planes located at up and down truncated planes of the bipyramidals may be reduced. It allows the titania nanoparticles to have larger surface area with decreased photoactivity. Thus, the titania nanoparticles having a truncated bipyramidal geometry with developed {101} crystallographic planes can contain much more amount of dyes for a long period of time. And, the adsorbed and remained dyes can provide for the solar cell to have high photoelectric conversion efficiency.

Preferably, a ratio of surface area of {101} crystallographic planes of the titania nanoparticles to that of {001} crystallographic planes may be 2 or greater. More preferably, the ratio may be 3 or greater.

An infrared spectroscopic spectrum of the titania nanoparticles adsorbing cis-Bis(isothiocyanato)bis(2,2′-bipyridyl-4,4′-dicarboxylato)ruthenium(II) dye may comprise bands at 1594 cm⁻¹, 1479 cm⁻¹ and 1106 cm⁻¹.

The adsorption rate may be examined by dye adsorption quantity of the titania nanoparticle 1 g within a dye solution 1 L of cis-bis(isothiocyanato)bis(2,2′-bipyridyl-4,4′-dicarboxylato)ruthenium(II) 3.0 mM dissolved in ethanol.

90% or more of dye molecules may remain on the surface of the titania nanoparticles when the titania nanoparticles adsorbed cis-bis(isothiocyanato)bis(2,2′-bipyridyl-4,4′-dicarboxylato)ruthenium(II) dye up to their saturation level are exposed under a metal-halogen lamp of 380 to 700 nm wavelength with 150 W at a distance of 15 cm, within the ambient condition, at the temperature of 30 to 40° C. for 17 hours.

The photo-electrode may have an absorption layer comprising the shape-controlled titania nanoparticles with dye adsorbents.

To achieve the above objects, it is also provided that a method for preparing a photo-electrode of a dye-sensitized solar cell comprising faceted anatase-type titania nanoparticles, the method comprising steps of: producing titania nanoparticles through a chemical vapor synthesis method using a titanium alkoxide precursor; post-annealing the titania nanoparticles to control the shape of titania nanoparticles having a faceted shape with a truncated bipyramidal geometry in which {101} crystallographic planes are developed; and applying the shape-controlled titania nanoparticles into a photo-electrode of a dye-sensitized solar cell as dye adsorbents.

The titanium alkoxide precursor may be any one selected from the group consisting of titanium tetraisopropoxide, titanium methoxide, titanium ethoxide, titanium butoxide, titanium tert-butoxide, titanium ethylhexoxide and combinations thereof.

The chemical vapor synthesis may be either a chemical vapor condensation or a flame pyrolysis.

The step of producing may be performed at the temperature of 1,000° C. or higher and the titania nanoparticles may be 15 nm or smaller in size. When the step of producing is performed at the temperature of 1,000° C. or higher, the sizes of titania nanoparticles can be small enough to control their shape easily and can develop {101} crystallographic planes of the faceted shape with a truncated bipyramidal geometry more easily through the step of post-annealing.

The step of post-annealing may be performed at 400° C. to 600° C. for 0.5 to 10 hours. For controlling the shape of the particle and developed planes, the temperature and time of post-annealing can be changed. For example, if the temperature is 400° C. to 500° C., the post-annealing may be performed 5 hours or longer. However, if the temperature is 500° C. to 600° C., the post-annealing may be performed 5 hours or shorter.

A specific surface area of the shape-controlled titania nanoparticles may be 80 m²/g or greater.

An adsorption rate of dye molecules may be 80% or more on a surface area of the shape-controlled titania nanoparticles within five minutes when the dye molecules in a solution are in contact with the shape-controlled titania nanoparticles.

An amount of dye molecules on the shape-controlled titania nanoparticles may be 90% or more of an initial amount thereof when the shape-controlled titania nanoparticles are exposed for 15 hours under a metal-halogen lamp.

The shape-controlled titania nanoparticles may have a ratio of surface area of {101} crystallographic planes to that of {001} crystallographic planes to be 2 or greater.

The adsorption rate of the shape-controlled titania nanoparticles is examined by dye adsorption quantity of the shape-controlled titania nanoparticle 1 g within a dye solution 1 L of cis-bis(isothiocyanato)bis(2,2′-bipyridyl-4,4′-dicarboxylato)ruthenium(II) 3.0 mM dissolved in ethanol.

90% or more of dye molecules may remain on the surface of the shape-controlled titania nanoparticles when the shape-controlled titania nanoparticles adsorbing cis-bis(isothiocyanato)bis(2,2′-bipyridyl-4,4′-dicarboxylato)ruthenium(II) dyes up to the saturation level are exposed under a metal-halogen lamp of 380 to 700 nm wavelength with 150 W at a distance of 15 cm, within the ambient condition, at the temperature of 30 to 40° C. for 17 hours.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a general configuration of a dye-sensitized solar cell (DSSC);

FIG. 2 is a transmission electron microscopy (TEM) photographs of (a) titania nanoparticles (named as KIST-0) fabricated by a chemical vapor synthesis and (b) titania nanoparticles (named as KIST-5) obtained by post-annealing the KIST-0;

FIG. 3 is a result of small angle X-ray scattering (SAXS) analysis showing the changed shape of the titania nanoparticles according to the post-annealing treatment;

FIG. 4 is a graph showing a UV-Vis absorption spectrum of N719 dye molecules;

FIG. 5 is a graph showing a UV-Vis absorption spectrum when N719 dye molecules are adsorbed, respectively, on the surface of titania nanoparticles (P25) and on the surface of titania nanoparticles (KIST-5);

FIG. 6 is a graph showing an infrared spectroscopic (IR) spectrum of the titania nanoparticles (P25) adsorbed N3 dye molecules on their surface;

FIG. 7 is a graph showing an infrared spectroscopic (IR) spectrum of the titania nanoparticles (KIST-5) adsorbed N3 dye molecules on their surface;

FIG. 8 is a graph showing an adsorption behavior of N719 dye molecules on a surface of titania nanoparticles (KIST-5 and P25);

FIG. 9 is a graph showing the decomposition of the N719 dye molecules adsorbed on the titania nanoparticles (KIST-5) during irradiation as a function of time; and

FIG. 10 is a graph showing the decomposition of the N719 dye molecules adsorbed on the titania nanoparticles (P25) during irradiation as a function of time.

FIG. 11 is a high resolution transmission electron microscopy (HRTEM) photograph of titania nanoparticles (named as KIST-5) obtained through post-annealing step. It is confirmed that the titania nanoparticles has a truncated bipyramidal geometry.

FIG. 12 shows a marked part of FIG. 11 in which 0.352 nm of the lattice plane spacing is observed. The d-spacing of 0.352 nm means (101) planes of faceted anatase type titania nanoparticle.

FIG. 13 illustrates a shape of a particle having a truncated bipyramidal geometry.

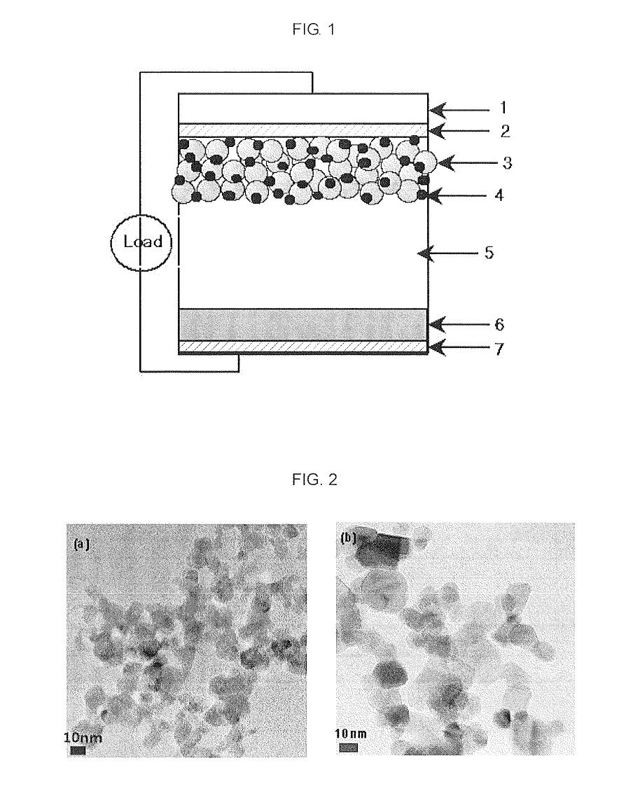

### MODES FOR CARRYING OUT THE PREFERRED EMBODIMENTS

Reference will now be made in detail to the preferred embodiments of the present invention, examples of which are illustrated in the accompanying drawings.

To obtain an efficient DSSC, the fabrication of photo-electrode layer using titania nanoparticles needs to meet following requirements: 1) A low temperature sintering technique to secure a high specific surface area and extend the scope of electrode substrates. It is also related to preserve open pores with high degree of porosity along with high connectivity of the titania nanoparticles in a photo-electrode layer. 2) Modification of surface characteristics and a shape of the titania nanoparticles to ensure high loading of dye molecules. The titania nanoparticles, which have a high crystallinity phase, crystallographic planes, particle morphology and surface functionality favorable for adsorbing dye molecules after fabrication of a photo-electrode, are required. It is important to control the shape and surface characteristics of the titania nanoparticles. 3) Controlling material characteristics of the titania nanoparticles so as to be less detrimental to dye molecules for lengthening the life of DSSC. So, it is required that titania nanoparticles having pure anatase phase and low photocatalytic degradation.

Thus, in an exemplary embodiment of the present invention, the titania nanoparticles are produced at a high temperature for a short period of reaction time and sintered at a low temperature in order to fulfill the above-mentioned requirements. As a result, they are pure anatase-type titania nanoparticles and have high crystallinity ensuring excellent electron mobility. In addition, they have sufficient specific surface area, and they are stable at the temperature of 450° C. for fabrication of photo-electrodes for high efficiency in DSSC, since they are treated at a high temperature during synthesis process. Also, the synthesized titania nanoparticles have a particle shape adequate for adsorbing dye molecules, and have the characteristics of slow decomposition rate of the dye molecules adsorbed on the surface of the titania nanoparticles, leading to the improved life span of the DSSC.

The titania nanoparticles for fabricating a DSSC photo-electrode according to an exemplary embodiment of the present invention have a faceted shape and an anatase phase having a truncated bipyramidal geometry with developed {101} crystallographic planes. The titania nanoparticles for a DSSC photo-electrode may have a specific surface area of 80 m²/g or greater, which is preferable for a sufficient adsorption of dye molecules.

The titania nanoparticles for the DSSC photoelectrode have an adsorption rate of that 80% or more of dye molecules are adsorbed on the surface of the titania nanoparticles within 5 minutes when the dye molecules are in contact with the surface of the titania nanoparticles. For example, 1 g of titania nanoparticles adsorbs up to 80% or more of dye molecuels within five minutes when they are in contact with a 1 L ethanol solution containing 3.0 mM cis-bis(isothiocyanato)bis(2,2′-bipyridyl-4,4′-dicarboxylato)ruthenium(II) dye molecules (referred to as ‘N719 dye molecules’, hereinafter).

90% or more of an initial amount of the dye molecules adsorbed on the surface of titania nanoparticles remain when they are exposed for 15 hours under a metal-halogen lamp. For example, 90% or more of dye molecules remained on the surface of the titania nanoparticles when the titania nanoparticles adsorbed N719 dyes up to the saturation level were exposed (an exposure position is 15 cm) for 17 hours under a metal-halogen lamp (Osram GmbH, model name: HQL-TS/NDL, 380 to 700 nm wavelength, 150 W) in the ambient condition at 30 to 40° C. This means the present invention has slow decomposition characteristics of the dye molecules adsorbed on the surface of the titania nanoparticles.

The method for fabricating a titania nanoparticle for a photo-electrode of DSSC is comprised of producing a titania nanoparticle from a titanium alkoxide precursor through a chemical vapor synthesis and post-annealing the titania nanoparticles to form a faceted particle shape having a truncated bipyramidal geometry with developed {101} crystallographic planes.

The titanium alkoxide precursor for fabricating the titania nanoparticle may be any one selected from the group consisting of titanium tetraisopropoxide, titanium methoxide, titanium ethoxide, titanium butoxide, titanium tert-butoxide, and titanium ethylhexoside, and the chemical vapor synthesis method may be a chemical vapor condensation or a flame pyrolysis.

The post-annealing treatment may be performed at 400° C. to 600° C. for 0.5 to 10 hours.

The anatase type titania nanoparticle for a photo-electrode of DSSC and a fabrication method thereof will now be described in detail with reference to the accompanying drawings.

FIG. 2 shows transmission electron microscopy (TEM, FEI Co., model name: Tecnai G2) photographs of titania nanoparticles. (a) is a photograph of the titania nanoparticles fabricated by chemical vapor synthesis named as KIST-0 and (b) is a photograph of the titania nanoparticles, obtained by post-annealing the KIST-0 named as KIST-5.

The titania nanoparticles in (a) have an irregularly spherical shape having about 115 m²/g as BET specific surface area and the titania nanoparticles in (b), obtained through post-annealing at 450° C. for five hours, have faceted shape of a truncated bipyramidal geometry with {101} crystallographic planes. The specific surface area of the post-annealed nanoparticles (b) is 93 m²/g.

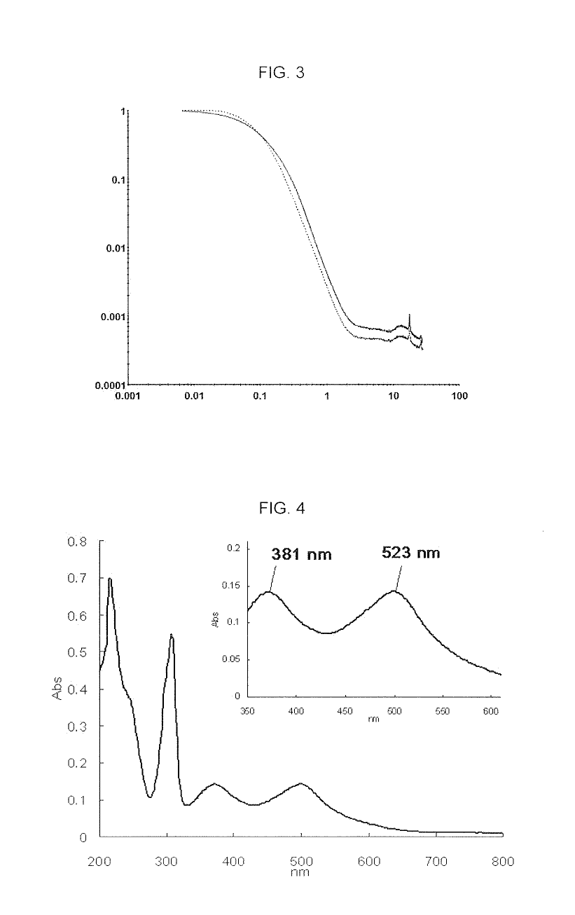

FIG. 3 is a result of small angle X-ray scattering (SAXS) analysis showing the shape change of the titania nanoparticles according to post-annealing (small angle X-ray scattering, SAXS, Anton Paar Co., model name: SAXSess mc2, measured in a state of solid). A SAXS graph of the KIST-0 fabricated through the chemical vapor synthesis is demonstrated by the solid line and that of the KIST-5 annealed after being fabricated is expressed by the dotted line. The X-axis represents a ‘q’ value of which unit is 1/nm, and the Y-axis represents a normalized intensity (I).

In the graph of FIG. 3, a flat ‘q’ value region (q<˜0.1 nm⁻¹) is called a Guinier area, and a high ‘q’ value region (2<q<10 nm⁻¹) is called a Porod area. A region between these two areas is of a fractal area, in which a transition of two areas is observed, which is related to the change of particle shape. The KIST-0 indicated by the solid line and the KIST-5 substantially have a shape close to a sphere, and it is noted that the titania nanoparticles indicated by the dotted line have a faceted shape in consideration of the facts that 1) the fractal area of the titania nanoparticles indicated by the dotted line starts later in time than that of the titania nanoparticles indicated by the solid line and 2) the slope of the fractal area of the titania nanoparticles indicated by the dotted line is less steep.

FIG. 4 is a graph showing a UV-Vis absorption spectrum of N719 dye molecules (UV-Vis Spectroscopy, Varian Co., model name: Carry100). The N719 dye molecules are dissolved in an ethanol solution. FIG. 4 shows visible light absorption bands at 523 nm and 381 nm by a metal-to-legand charge transfer (MLCT).

FIG. 5 is a graph showing a UV-Vis absorption spectrum (UV-Vis Spectroscopy, Varian Co., model name: Carry100) when the N719 dye molecules are adsorbed on the surface of the P25 (titania nanoparticles chosen for comparison) and on the surface of the KIST-5. Line (a) means an absorption spectrum obtained by adsorbing the N719 dye molecules on the surface of the P25 and drying the same at 100° C. It is noted that after the dye molecules are adsorbed on the surface of the titania nanoparticles, the MLCT peak is red-shifted by 48 nm toward lower energy side (571 nm). Such a red shift is known to occur as the carboxyl groups of the dye molecules are coupled on the surface of the titania nanoparticles and affected by positive charge of the titanium ions (Ti⁴⁺) of the surface thereof [J. Phys, Chem. B, 107, 8981 (2003)]. Line (b) is an absorption spectrum obtained by adsorbing the N719 dye molecules on the surface of the KIST-5 titania nanoparticles and drying it in the same manner. It is noted that the MLCT of the dye molecules on the surface appears at 547 nm, indicating that it is red-shifted by 24 nm compared with the solution state and blue-shifted by 24 nm compared with the surface adsorption for the P25. The adsorption behavior of the dye molecules appearing on the surface of the KIST-5 means that the surface characteristics of the KIST-5 and those of the P25 are quite different.

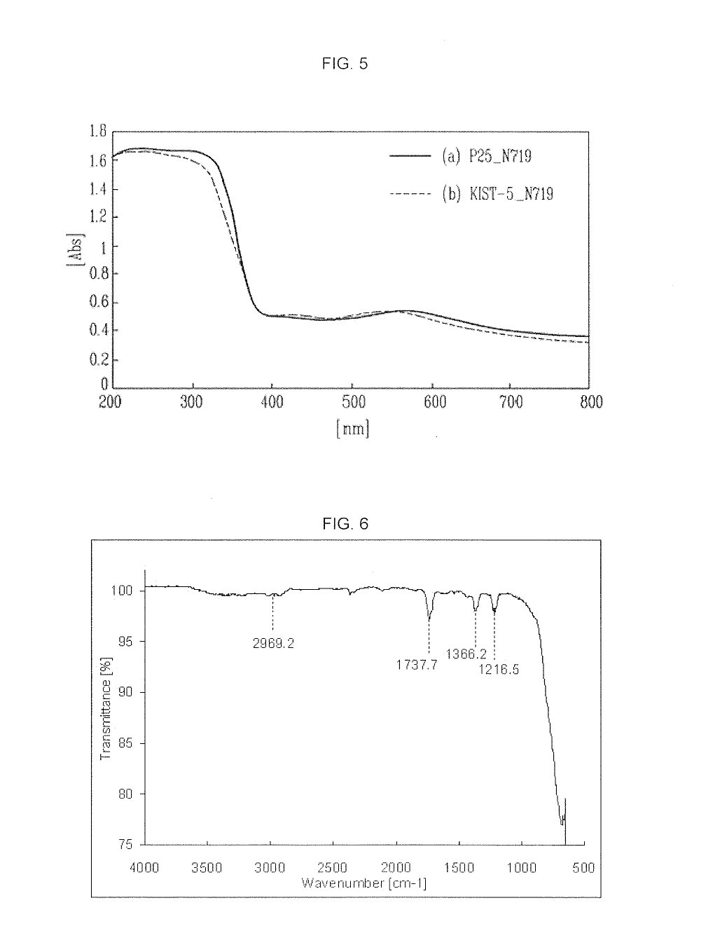

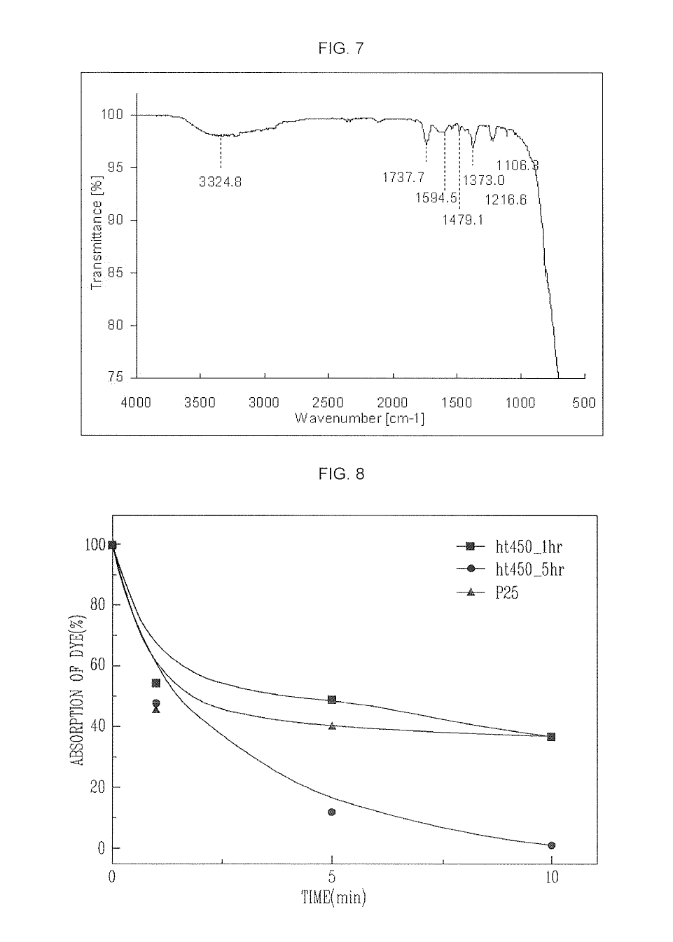

FIG. 6 is a graph showing an infrared spectroscopic spectrum of the P25 adsorbing N3 dye molecules on the surface thereof (FT-IR spectrometer of Thermo-Mattson Co., model name: Infinity gold FT-IR, attenuated total reflectance (ATR) measurement), and FIG. 7 is a graph showing an infrared spectroscopic spectrum of the KIST-5 adsorbing N3 dye molecules on the surface thereof. The bands at 1737 cm⁻¹ and at 1216 cm⁻¹ are caused, respectively, by a C═O double bond of carboxyl group of dye and a C—O single bond of carboxyl group of dye. Both bands appear commonly in two powders. In connection with a symmetrical stretching band (—COO⁻) appearing in the vicinity of 1370 cm⁻¹, it appears at 1366 cm⁻¹ in FIG. 6 and at 1373 cm⁻¹ in FIG. 7. It is noted that additional bands (1594, 1479, and 1106 cm⁻¹) appear on the spectrum of the KIST-5. This means there are bonds with more various modes on the surface of the KIST-5 in contrast with them on the surface of the P25 when the N3 dye molecules are adsorbed on them, implying that the surface characteristics of them are remarkably different.

FIG. 8 is a graph showing an adsorption behavior of N719 dye molecules on a surface of titania nanoparticles. In FIG. 8, it is noted that 80% or more of dye molecules are adsorbed on the KIST-5 within five minutes when they are in contact with a 1 L ethanol solution containing 3.0 mM N719 dye molecules, whereas only 55% of dye molecules are adsorbed on the P25. This observation means that the dye molecules are adsorbed more quickly by about one and half times on the KIST-5 than, as an example, on the P25.

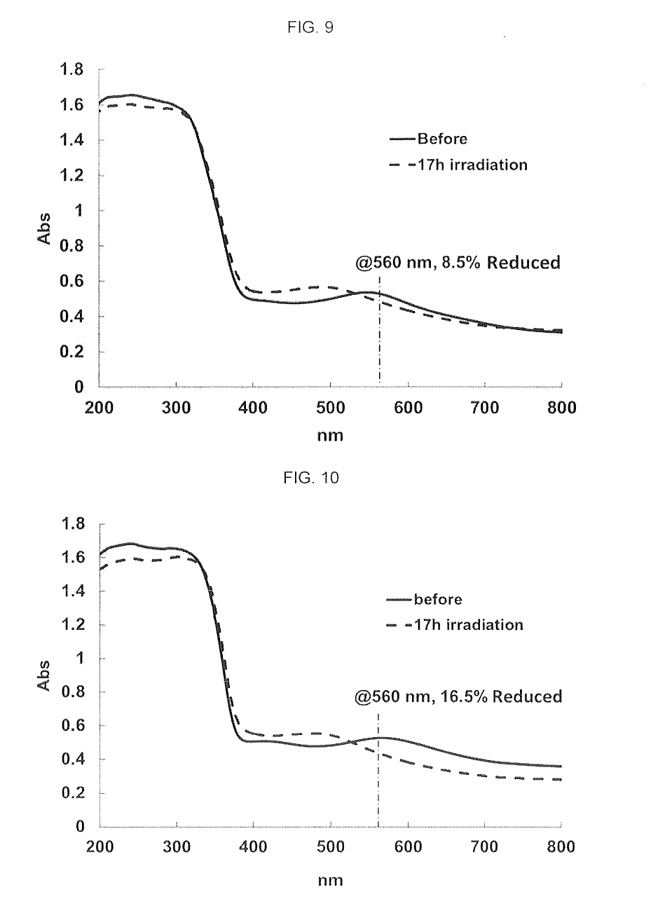

FIGS. 9 and 10 are graphs showing the decomposition of N719 dye molecules adsorbed on the KIST-5 and on the P25 as a function of time during irradiation. They show the reflective absorption spectrums of the KIST-5 and the P25, positioned at a distance of 15 cm away from a metal-halogen lamp (Osram GmbH, model name: HQL-TS/NDL, 380 to 700 nm wavelength, 150 W). It is noted that the decomposition rate of the dye molecules adsorbed on the surface of the KIST-5 is by about half times slower than that of the dye molecules adsorbed on the surface of the P25.

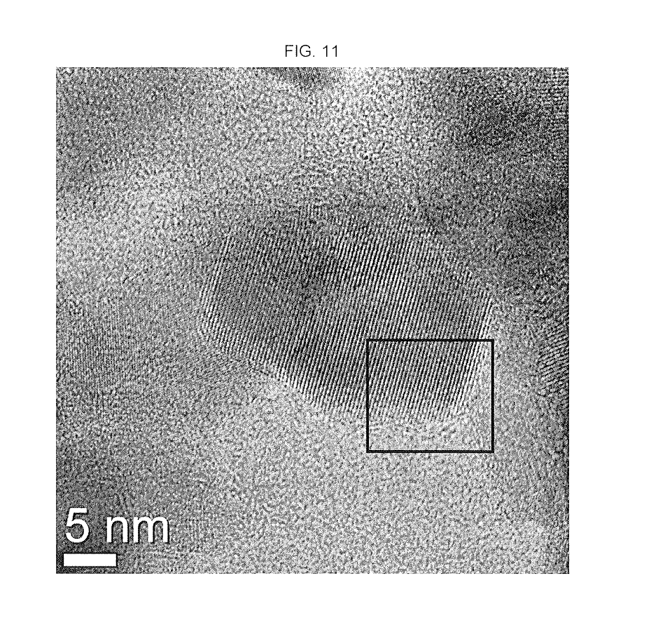

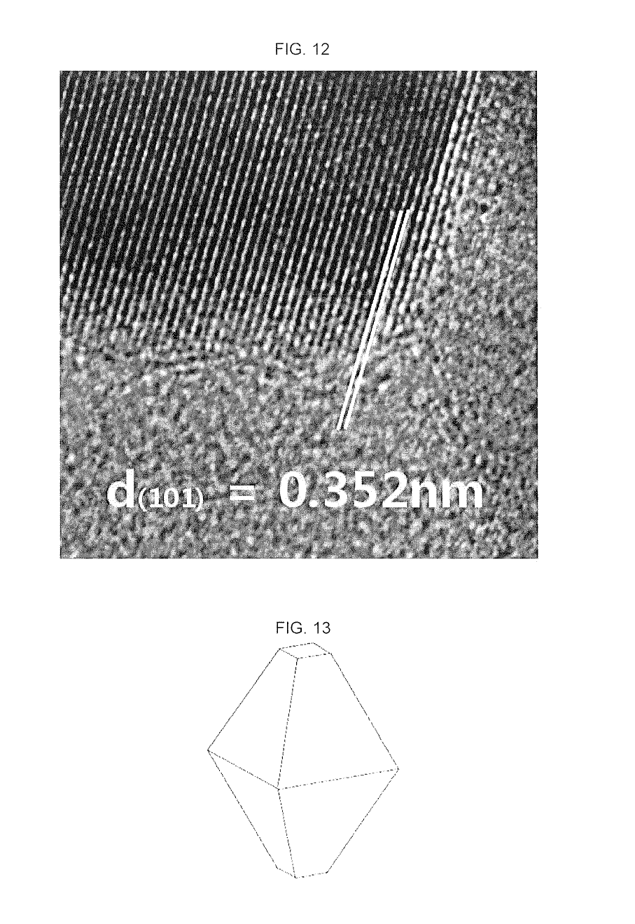

FIGS. 11 and 12 show high resolution transmission electron microscopy (HRTEM, FEI Co., model name: Tecnai G2) photograph of titania nanoparticles (named as KIST-5) obtained through post-annealing step and its marked part. Referring to FIG. 11, it is confirmed that the titania nanoparticles has a truncated bipyramidal geometry. Also, referring to FIG. 12, the lattice plane spacing observed in HRTEM determines 0.352 nm which means (101) planes of faceted anatase-type titania nanoparticle.

Table 1 shows particle characteristics of the KIST-0 without post-annealing treatment and the KIST-5 with post-annealing treatment. A specific surface area of them are measured by nitrogen adsorption method with Surface Area Analyzer device (model name: BELSORPmax of BEL Japan, Inc.) after they are heated at 100° C. for 1 hour in vacuum.

Ingredient phases in the KIST-0 and the KIST-5 were determined using TTK450 model XRD device of Anton Paar Co.

TABLE 1

| | | Specific surface | |
|---|---|---|---|
| | | area | Pore volume |
| | Crystal phase | (BET, m²/g) | (cm³/g) |
| KIST-0 | Anatase 100% | 115 | 0.41 |
| KIST-5 | Anatase 100% | 93 | 0.40 |

Table 2 shows characteristics of the DSSCs fabricated using the KIST-0 and the KIST-5, respectively.

TABLE 2

| | Specific | | | | |
|---|---|---|---|---|---|
| | surface | | | | |
| | area (BET, | | | | |
| | m²/g) | JSC | VOC | f.f | Efficiency |
| KIST-0 | 115 | 10.7 | 0.76 | 75.5 | 6.1 |
| KIST-5 | 93 | 12.37 | 0.765 | 76.0 | 7.1 |

### EXAMPLES

The present invention will be described through examples. However, the examples are parts of various embodiments of the present invention and the present invention is not limited thereto.

### Example 1

Titania nanoparticles were fabricated at 1000° C. from titanium tetraisopropoxide as a precursor through a chemical vapor condensation. Oxygen gas was used as an oxidizing gas and nitrogen gas was used as a carrier gas. The fabricated titania nanoparticle had a specific surface area of 115 to 120 m²/g, determined as a crystal form of pure anatase phase, and an round shape (See (a) of FIG. 2). The fabricated titania nanoparticles were post-annealed at 450° C. for 5 hours in the air to form titania nanoparticles named as KIST-5, their specific surface area was reduced and their shape was changed to a faceted form (See (b) of FIG. 2 and Table 1).

### Example 2

The adsorption behavior of dye molecules on the titania nanoparticle with post-annealed treatment in Example 1 was determined.

It was prepared a dye solution containing 3.0 mM of N719 dye molecules in ethanol solvent and P25 was adapted as a titania nanoparticle for a comparative example.

1 g of the KIST-5 with post-annealing treatment at 450° C. for five hours and 1 g of the P25 were dispersed in 1 L of the dye solution, respectively, and concentrations of the dye molecules in the supernatant dye solution were measured for determining an absorption rate of dye molecules.

For determining an adsorption rate of dye molecules, 1 mL of mixture solutions, which are the dye solutions containing the respective titania nanoparticles, were taken in predetermined time with some interval, respectively. And the titania nanoparticles adsorbing dye molecules are removed from the mixture solutions with centrifugal separation. The adsorption rates of the dye molecules were determined using the supernatant dye solutions by UV-Vis absorption spectrum of 500 nm wavelength (See FIG. 8).

The adsorption speed of the KIST-5 post-annealed for 5 hours (showing 88%) was by about 1.5 times faster than that of the P25 (showing 58%) at 5 minutes.

### Example 3

The decomposition behavior of N719 dye molecules adsorbed on the KIST-5 titania nanoparticles annealed at 450° C. for 5 hours demonstrated in Example 1 was determined. P25 (titania nanoparticles) adsorbing N719 dye molecules was used as a comparative example,

0.8 g of the KIST-5 and P25 were taken, dispersed in 5 mL methanol, and then dispersed in the Petri dish of 9 cm ID, respectively.

Methanol in the petri dishes was completely evaporated at 50° C. and the remaining titania nanoparticles in each dishes were dried in the oven at 60° C. In the each petri dish, there was a membrane having light pink color.

The petri dishes including the membrane were cooled to room temperature and were put at a position of 15 cm under the metal-halogen lamp in the air for 17 hours. The temperature around the petri dishes was over 35 to 40° C. due to radiant heat.

The membrane was scraped off from the dishes to get samples from the KIST-5 and the P25. UV-Vis absorption spectrum of the samples was measured in the solid state (See FIGS. 9 and 10).

Comparing the sample from the KIST-5 with that from the P25, the decomposition speed of the dye molecules in the P25 were by about two times faster than that of the dye molecules in the KIST-5.

This means the titania nanoparticles in the present invention have a lower decomposition rate than the comparative example (P25), leading to expansion of a life span when they are used as a photo-electrode of a dye-sensitized solar cell.

### Example 4

A DSSC was fabricated from the titania nanoparticles (KIST-0 and KIST-5), wherein KIST-5 was obtained by post-annealing the KIST-0 prepared likely in Example 1.

Titania pastes incorporating the KIST-0 and the KIST-5, respectively, were prepared and were coated on the surface of conductive substrates, FTO (fluorine doped tin oxide) coated glasses, for a photo-electrodes, dried them at 70° C. for 30 minutes, and then thermally treated them at 450° C. for 1 hour to fabricate titania photo-electrodes. The titania photo-electrodes were immersed in the N719 dye solution for 24 hours to adsorb the dye molecules on the surface of porous titania photo-electrodes. The substrates coated with platinum thin film were used as counter electrodes. An adhesive film was placed along the periphery of a cell between the counter electrode and the photo-electrode and heated to induce hermetic sealing. Then, electrolyte (I₃) was injected between the two electrodes. Photoelectric conversion efficiency of the cells was measured by analyzing current-voltage curve data obtained from the DSSCs fabricated through the foregoing method. For a simulation of the current-voltage curve, commonly available CHI660A was used. An AM 1.5 filter and 1000 W Xenon lamp, commonly used in measuring the performance of a solar cell, was employed as artificial solar light. From the characterization of DSSCs fabricated from the titania nanoparticles of KIST-0 and KIST-5, it was confirmed that photoelectric conversion efficiency was improved by about 15% and in particular, current density was improved by 15% or more, respectively, by the post-annealing treatment.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A photo-electrode of a dye-sensitized solar cell, comprising; faceted anatase-type titania nanoparticles having a truncated bipyramidal geometry with developed {101} crystallographic planes, wherein an adsorption rate of dye molecules is 80% or greater on the surface of the titania nanoparticles within five minutes when the dye molecules in a solution are in contact with the titania nanoparticles.

2. The photo-electrode of claim 1, wherein the specific surface area of the titania nanoparticles are 80 m²/g or greater.

3. The photo-electrode of claim 1, wherein an amount of dye molecules adsorbed on the surface of the titania nanoparticles is 90% or more of an initial amount thereof when the titania nanoparticles adsorbing the dye molecules are exposed for 15 hours under a metal-halogen lamp.

4. The photo-electrode of claim 1, wherein a ratio of surface area of {101} crystallographic planes of the titania nanoparticles to that of {001} crystallographic planes is 2 or greater.

5. The photo-electrode of claim 1, wherein an infrared spectroscopic spectrum of the titania nanoparticles adsorbing cis-Bis(isothiocyanato)bis(2,2′-bipyridyl-4,4′-dicarboxylato)ruthenium(II) dye comprises bands at 1594 cm⁻¹, 1479 cm⁻¹ and 1106 cm⁻¹.

6. The photo-electrode of claim 1, the adsorption rate is examined by dye adsorption quantity of the titania nanoparticle 1 g within a dye solution 1 L of cis-bis(isothiocyanato)bis(2,2′-bipyridyl-4,4′-dicarboxylato)ruthenium(II) 3.0 mM dissolved in ethanol.

7. The photo-electrode of claim 1, wherein 90% or more of dye molecules remains on the surface of the titania nanoparticles when the titania nanoparticles adsorbing cis-bis(isothiocyanato)bis(2,2′-bipyridyl-4,4′-dicarboxylato)ruthenium(II) dye up to their saturation level are exposed under a metal-halogen lamp of 380 to 700 nm wavelength with 150 W at a distance of 15 cm, within the ambient condition, at the temperature of 30 to 40° C. for 17 hours.

8. The photo-electrode of claim 1, wherein the photo-electrode has an absorption layer comprising the shape-controlled titania nanoparticles with dye adsorbents.

9. A method for preparing a photo-electrode of a dye-sensitized solar cell comprising faceted anatase-type titania nanoparticles, the method comprising steps of:
producing titania nanoparticles through a chemical vapor synthesis method using a titanium alkoxide precursor;
post-annealing the titania nanoparticles to control the shape of titania nanoparticles having a faceted shape with a truncated bipyramidal geometry in which {101} crystallographic planes are developed; and
applying the shape-controlled titania nanoparticles into a photo-electrode of a dye-sensitized solar cell as dye adsorbents.

10. The method of claim 9, wherein the titanium alkoxide precursor is any one selected from the group consisting of titanium tetraisopropoxide, titanium methoxide, titanium ethoxide, titanium butoxide, titanium tert-butoxide, titanium ethylhexoxide and combinations thereof.

11. The method of claim 9, wherein the chemical vapor synthesis is either a chemical vapor condensation or a flame pyrolysis.

12. The method of claim 9, wherein the step of producing is performed at the temperature of 1,000° C. or higher and the size of titania nanoparticles are 15 nm or smaller in average.

13. The method of claim 9, wherein the step of post-annealing is performed at 400° C. to 600° C. for 0.5 to 10 hours.

14. The method of claim 9, wherein a specific surface area of the shape-controlled titania nanoparticles is 80 m²/g or greater.

15. The method of claim 9, wherein an adsorption rate of dye molecules is 80% or more on a surface area of the shape-controlled titania nanoparticles within five minutes when the dye molecules in a solution are in contact with the shape-controlled titania nanoparticles.

16. The method of claim 9, wherein an amount of dye molecules on the shape-controlled titania nanoparticles is 90% or more of an initial amount thereof when the shape-controlled titania nanoparticles are exposed for 15 hours under a metal-halogen lamp.

17. The method of claim 9, wherein the shape-controlled titania nanoparticles have a ratio of surface area of {101} crystallographic planes to that of {001} crystallographic planes to be 2 or greater.

18. The method of claim 15, wherein the adsorption rate of the shape-controlled titania nanoparticles is examined by dye adsorption quantity of the shape-controlled titania nanoparticle 1 g within a dye solution 1 L of cis-bis(isothiocyanato)bis(2,2′-bipyridyl-4,4′-dicarboxylato)ruthenium(II) 3.0 mM dissolved in ethanol.

19. The method of claim 9, wherein 90% or more of dye molecules remains on the surface of the shape-controlled titania nanoparticles when the shape-controlled titania nanoparticles adsorbed cis-bis(isothiocyanato)bis(2,2′-bipyridyl-4,4′-dicarboxylato)ruthenium(II) dyes up to the saturation level are exposed under a metal-halogen lamp of 380 to 700 nm wavelength with 150 W at a distance of 15 cm, within the ambient condition, at the temperature of 30 to 40° C. for 17 hours.
